(19) United States
(12) Patent Application Publication
(10) Pub. No.: US 2001/0053948 A1
(43) Pub. Date: Dec. 20, 2001

(54) APPARATUS AND METHOD FOR LAYING OUT TRANSISTOR IN SEMICONDUCTOR INTEGRATED CIRCUIT ALLOWING EFFICIENT LAYOUT EDITING, AND METHOD FOR MANUFACTURING SEMICONDUCTOR INTEGRATED CIRCUIT USING THE SAME METHOD

(76) Inventors: SATORU KISHIDA, HYOGO (JP); TAKAHIRO ODA, HYOGO (JP)

Correspondence Address: MCDERMOTT WILL & EMERY, 600 13TH STREET, N.W., WASHINGTON, DC, 20005-3096, US

(21) Appl. No.: 09/088,368

(22) Filed: Jun. 2, 1998

(30) Foreign Application Priority Data
Dec. 4, 1997 (JP) 9-334158

(51) Int. Cl. G06F 19/00

(52) U.S. Cl. 700/121

(57) ABSTRACT

A layout apparatus allowing efficient layout editing includes a circuit for selecting a logic gate forming a semiconductor integrated circuit, and a circuit for generating, on the basis of a logic gate, a layout cell of transistors forming the logic gate based on the size information on the transistors forming the logic gate and the type of the logic gate.

### BACKGROUND OF THE INVENTION

1. Field of the Invention

The present invention relates to an apparatus and method for laying out a transistor in a semiconductor integrated circuit as well as a method for manufacturing a semiconductor integrated circuit using the same method. More specifically, the present invention relates to an apparatus and method for laying out a transistor in a semiconductor integrated circuit which allow efficient layout editing as well as a method for manufacturing a semiconductor integrated circuit using the same method.

2. Description of the Background Art

Referring to FIG. 1, a conventional layout apparatus 30 includes a computer 32, a keyboard 40 and a mouse 42 for giving an instruction to computer 32, a display 34 for displaying, for example, a layout result obtained by computer 32, and a magnetic tape device 36, a CD-ROM (Compact Disk-Read Only Memory) device 44 and a communication modem 48 for reading a program executed by computer 32.

A program for laying out a transistor is recorded on a magnetic tape 38 or a CD-ROM 46 which are computer-readable record media, and it is read by magnetic tape device 36 and CD-ROM device 44, respectively. Besides, the program is read by communication modem 48 through a communication channel.

Referring to FIG. 2, computer 32 includes a CPU (Central Processing Unit) 50 for executing a program which is read through magnetic tape device 36, CD-ROM device 44 or communication modem 48, a ROM (Read Only Memory) 52 for storing other programs and data which are necessary for the operation of computer 32, a RAM (Random Access Memory) 54 for storing, for example, a program, a parameter in executing the program and an operation result, and a magnetic disk 56 for storing, for example, a program and data.

Referring to FIGS. 1-4, a conventional method for laying out a transistor using layout apparatus 30 will be described.

A circuit-diagram window is opened on display 34. Referring to FIG. 4, circuit information on a semiconductor integrated circuit stored in magnetic disk 56 is read out, and the circuit diagram 200 of the semiconductor integrated circuit at a transistor level is displayed on the circuit-diagram window (FIG. 4, S50). As an example, referring to FIG. 3, circuit diagram 200 shows an NAND gate 62 for outputting the NAND operation of inputs A and B, an NOT gate 66 for outputting the negative value of an input C, and an NAND gate 64 for outputting the NAND operation (output D) of outputs from NAND gate 62 and NOT gate 66. NAND gate 62 includes P channel transistors 186, 188 and N channel transistors 190, 192. Similarly, NAND gate 64 and NOT gate 66 include one or more P and N channel transistors.

A layout window is opened on display 34 (S51). A user selects a transistor on the layout window and reads additional information, for example, on the type, gate length and gate width of the selected transistor from magnetic disk 56 (S52). Based on the additional information read out of magnetic disk 56, a layout cell for the one selected transistor is displayed on the layout window (S53). A determination is made whether there is any additional layout cell to be displayed (S54). If there is any (YES at S54), the process steps of S52 and S53 are repeated.

If there is no additional layout cell to be displayed (NO at S54), the layout displayed on the layout window is edited (S55). The layout is edited interactively with the user. The user determines whether there is any additional layout cell to be displayed or any layout editing to be redone (S56). If there is any (YES at S56), the process steps after S52 are repeated.

If there is not (NO at S56), information on connection between transistors which form circuit diagram 200 displayed on the circuit-diagram window is read out of magnetic disk 56 (S57). The information on connection between transistors specifies connection between the terminals of the transistors, indicating “P channel transistor 188 and N channel transistor 190 are connected in series”, for example.

Based on the information on connection between transistors, the transistors are automatically interconnected on the layout window (S58). The user determines whether there is any process step so far to be redone or added (S59). If there is any (YES at S59), the process steps after S52 are repeated.

If there is not (NO at S59), compaction for closing unnecessary gaps formed by layout cells and interconnections is performed to compress the layout (S60). The user determines whether there is any process step to be redone or added (S61). If there is any (YES at S61), the steps after S52 are repeated. If there is not (NO at S61), the transistor layout is completed.

In a conventional layout apparatus 31, a layout cell has been generated for every transistor shown in circuit diagram 200. Since a transistor and a layout cell accordingly have one-to-one correspondence, connection between the terminals of the transistors can simply be determined, and a layout apparatus can easily be implemented. However, the layout cannot efficiently be generated. For example, in a circuit which is equivalent even if input signals are exchanged between two transistors, not only do interconnections have to be changed on the layout window but the transistor cell itself has to be replaced in order to exchange the input signals. Therefore, it takes considerable time for laying out.

Further, since the layout cell is generated on the basis of a transistor, a logic gate has to be constructed by combining the layout cells. Therefore, the whole image cannot be obtained at the initial stage of laying out, and thus laying out can not be performed efficiently.

Accordingly, laying out can not be performed in an optimum manner in a limited time period for designing, and the layout area is increased.

### SUMMARY OF THE INVENTION

The present invention is aimed at solving these problems. An object of the present invention is to provide a layout apparatus and method allowing efficient layout editing as well as a method for manufacturing a semiconductor integrated circuit using the layout method.

Another object of the present invention is to provide a layout apparatus and method capable of generating a layout with a high degree of integration as well as a method for manufacturing a semiconductor integrated circuit using the layout method.

An apparatus for laying out a transistor in a semiconductor integrated circuit according to one aspect of the present invention includes a circuit for selecting a logic gate forming the semiconductor integrated circuit, and a circuit for generating, on the basis of a logic gate, a layout cell of transistors forming the logic gate based on the size information and the logic gate type of the transistors forming the logic gate.

Since the layout cell is generated on the basis of a logic gate, the whole image can easily be obtained at the initial stage of laying out, and thus a layout is edited easily. Therefore, the layout can be edited efficiently.

Preferably, the layout apparatus further includes an interconnection portion for interconnecting layout cells based on information on connection between transistors forming the logic gate.

Therefore, interconnections between the transistors can be laid out more efficiently.

More preferably, the information on connection between transistors includes the terminal names of transistor terminals. The interconnection portion includes a terminal name rearranging portion, and a circuit for interconnecting terminals which have the same terminal name between layout cells based on the rearranged terminal names.

After the terminal names are rearranged, interconnections between the transistors are laid out. Therefore, the interconnection length and the layout cell arrangement area can be reduced, and the layout of transistors with a high degree of integration can be obtained.

A method for laying out a transistor in a semiconductor integrated circuit according to another aspect of the present invention includes the steps of selecting a logic gate forming the semiconductor integrated circuit, and generating, on the basis of a logic gate, a layout cell of transistors forming the logic gate based on the size information and the logic gate type of the transistors forming the logic gate.

Since the layout cell is generated on the basis of a logic gate, the whole image can easily be obtained at the initial stage of laying out and thus a layout is edited easily. Therefore, the layout can be edited efficiently.

Preferably, the method for laying out further includes the step of interconnecting layout cells based on information on connection between transistors forming the logic gate.

Therefore, interconnections between the transistors can be laid out more efficiently.

More preferably, the information on connection between transistors includes the terminal names of transistor terminals. The step of interconnecting includes the steps of rearranging the terminal names, and interconnecting terminals which have the same terminal name between the layout cells based on the rearranged terminal names.

After the terminal names are rearranged, interconnections between the transistors are laid out. Therefore, the interconnection length and of the layout cell arrangement area can be reduced, and the layout of transistors with a high degree of integration can be obtained.

A method for manufacturing a semiconductor integrated circuit according to still another aspect of the present invention includes the steps of laying out a transistor in the semiconductor integrated circuit, and manufacturing the semiconductor integrated circuit based on the result of the step of laying out. The step of laying out includes the steps of selecting a logic gate forming the semiconductor integrated circuit and generating, on the basis of a logic gate, a layout cell of transistors forming the logic gate based on the size information and the logic gate type of the transistors forming the logic gate.

Since the layout cell is generated on the basis of a logic gate, the whole image can easily be obtained at the initial stage of laying out, and thus a layout is edited easily. Therefore, the layout can be edited efficiently.

Preferably, the method for manufacturing a semiconductor integrated circuit further includes the step of interconnecting layout cells based on information on connection between transistors forming the logic gate.

Therefore, interconnections between the transistors can be laid out more efficiently.

More preferably, the information on connection between transistors includes the terminal names of transistor terminals. The step of interconnecting includes the steps of rearranging the terminal names, and interconnecting terminals which have the same terminal name between layout cells.

After the terminal names are rearranged, interconnections between the transistors are laid out. Therefore, the interconnection length and the layout cell arrangement area can be reduced, and the degree of integration of a semiconductor integrated circuit can be increased.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a conventional layout apparatus.

FIG. 2 is a block diagram of the conventional layout apparatus.

FIG. 3 is a logic circuit diagram at a transistor level.

FIG. 4 is a flow chart showing the processing of the conventional layout apparatus.

FIG. 5 is a flow chart showing the processing of a layout apparatus according to one embodiment of the present invention.

FIG. 6 is a logic circuit diagram at a logic gate level.

FIG. 7 is a view for describing a base layout.

FIG. 8 is a diagram for describing the dimensional definition of a transistor.

FIG. 9 is a diagram for describing the generation processing for generating a layout.

FIG. 10 is a circuit diagram of an NAND-NOR gate.

FIG. 11 describes information for arranging a transistor layout cell.

FIGS. 12A-12B show one example of the transistor layout.

FIGS. 13A-13C show one example of the transistor layout.

FIGS. 14A-14B show one example of the transistor layout.

FIG. 15 is a diagram for describing the processing for interconnecting transistors.

FIGS. 16A-16B are views for describing information for connecting transistors.

FIG. 17 is a flow chart showing the processing for rearranging transistor terminal names.

FIG. 18 shows the result after the transistor terminal names are rearranged.

FIGS. 19A-19B show layouts before and after the transistor terminal names are rearranged.

FIG. 20 shows a layout of a semiconductor integrated circuit designed by the layout apparatus.

### DESCRIPTION OF THE PREFERRED EMBODIMENTS

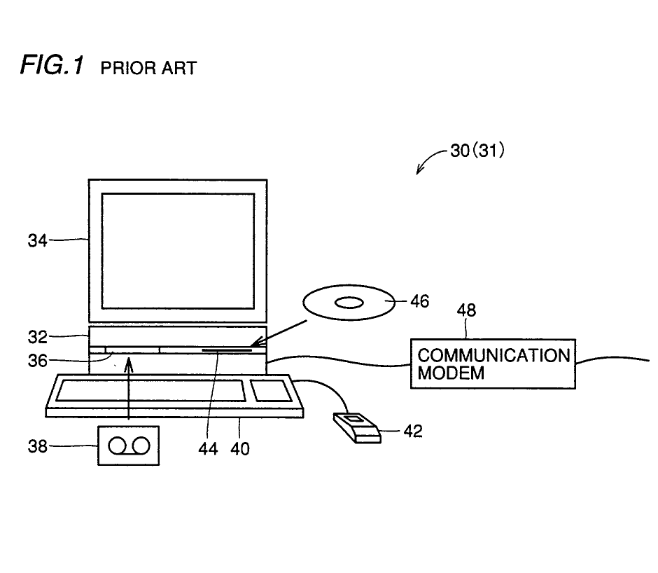

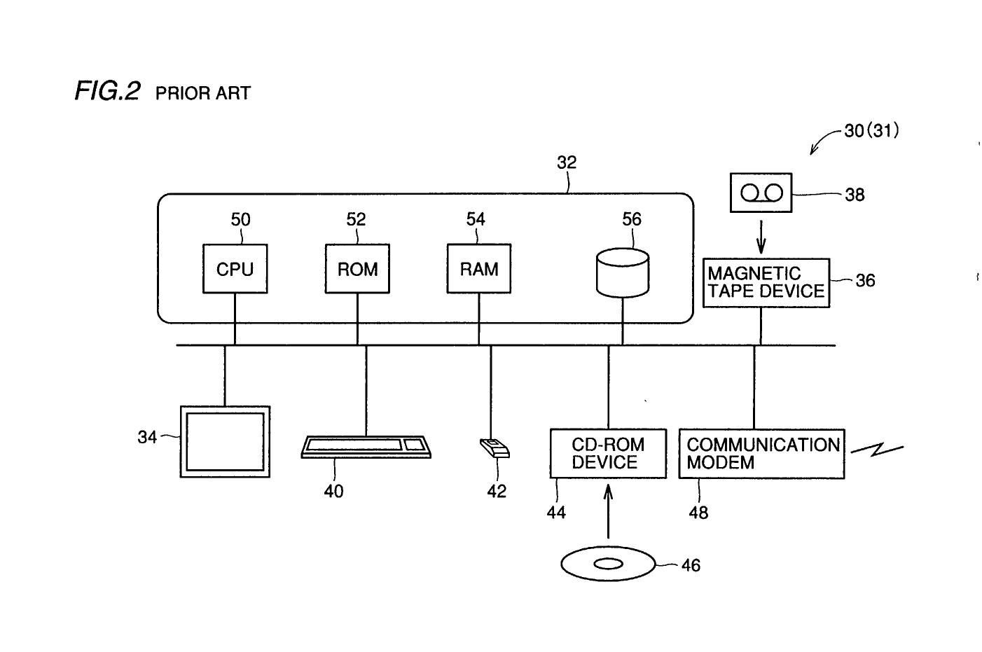

A layout apparatus 31 according to one embodiment of the present invention has the same structure as a conventional layout apparatus 30 described with respect to FIGS. 1 and 2. Therefore, the description of layout apparatus 31 will not be repeated.

A method for laying out a transistor using layout apparatus 31 will be described below with respect to the drawings.

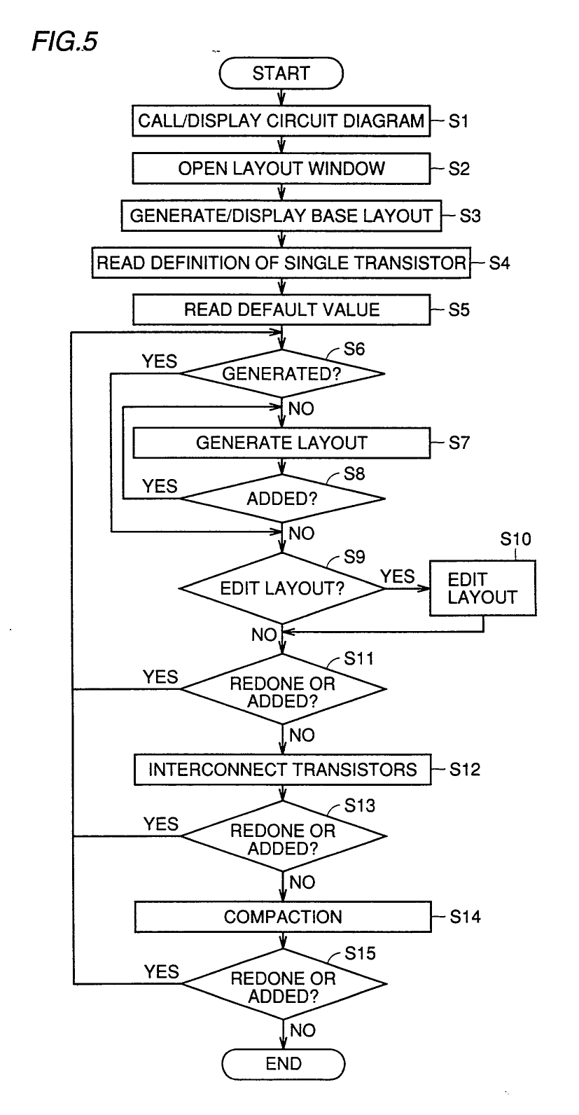

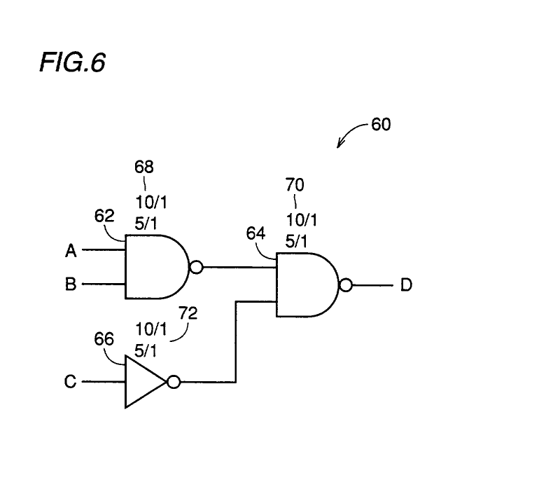

First, a circuit-diagram window is opened on a display 34. Referring to FIG. 5, circuit information on a semiconductor integrated circuit which is stored in a magnetic disk 56 is read out and displayed on the circuit-diagram window (S1). Actually, a circuit diagram 60 at a logic gate level as shown in FIG. 6 is displayed. As an example, circuit diagram 60 shows an NAND gate 62 for outputting the NAND operation of inputs A and B, an NOT gate 66 for outputting the negative value of an input C, and an NAND gate 64 for outputting the NAND operation (output D) of outputs from NAND gate 62 and NOT gate 66. Further, the gate length and gate width of P channel transistors and N channel transistors which form gates 62-66 are shown as transistor size information 68-72 in circuit diagram 60.

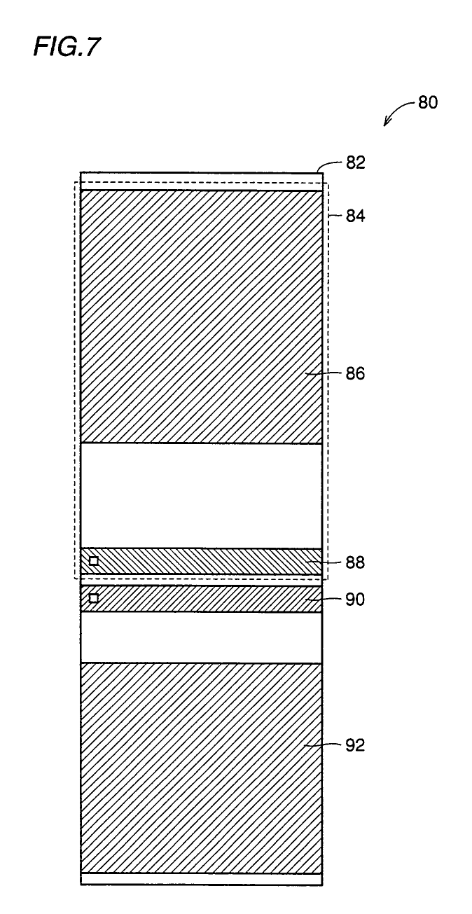

Referring to FIG. 5, a layout window is opened on display 34 (S2). Referring to FIG. 7, information on a base layout 80 is read out of magnetic disk 56 and displayed on the layout window (S3). For example, base layout 80 includes a second-layer metal interconnection region 86 for a power supply, a second-layer metal interconnection region 92 for a ground, guard rings 88 and 90, a well 84, and a cell frame 82.

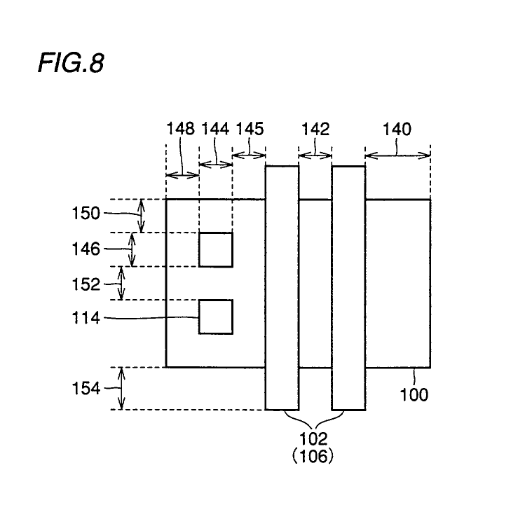

The definition of transistor dimension for laying out a transistor is read from magnetic disk 56 (S4). Referring to FIG. 8, the transistor dimension is defined, for example, by the distance 142 between P channel transistors 102/N channel transistors 106, the width 140 of an island in the active region in the x direction, the sizes 144 and 146 of a contact hole 114 in the x and y directions, respectively, the distance 152 between contact holes 114, the distances 148 and 150 in the x and y directions, respectively, between the top-left-end reference point of the one contact hole 114 which serves as a basis for arranging a plurality of contact holes 114 and the top-left-end reference point of island 100 in the active region, the size 154 of a projection of P channel transistor 102 (N channel transistor 106) in island 100 in the active region, and the distance 145 between contact hole 114 and P channel transistor 102/N channel transistor 106.

Default values such as the name of a layer, the width of an interconnection, the channel length of a transistor are read from magnetic disk 56 (S5). These default values are used for interconnecting transistors in the processing described below as long as there is not any particular designation.

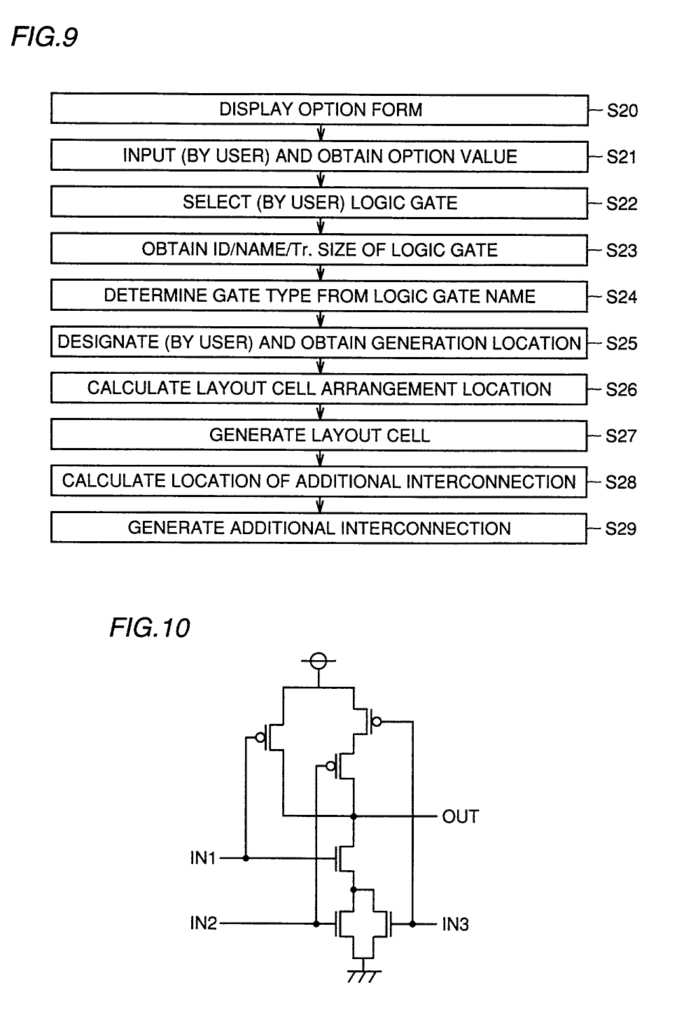

Then, a determination is made whether a layout of transistors forming a designated logic gate has been generated (S6). If the layout has been generated, the process step of S9 described below is performed. If the layout has not been generated, the layout of transistors forming the designated logic gate is generated (S7). The process step of S7 will be described below with reference to FIGS. 9-12.

An option form is displayed on display 34 (S20). Various settings are made on the option form by a user (S21). That is, the user designates a circuit of which transistors are laid out, designates a window on which a layout is generated, sets the conditions as to whether each transistor is generated to be divided into a plurality of transistors and, if it is, as to how many portions each transistor is divided into, and sets the upper limit of a transistor channel width if each transistor is not generated to be divided into a plurality of transistors. The user also sets the conditions as to the distance between a set of P channel transistors and a set of N channel transistors, as to where on the base layout the transistors are initially placed, as to whether the transistors and a power supply are interconnected, as to whether the transistors and a ground are interconnected, and, when a node having the same potential is divided into a plurality of nodes in the sets of P and N channel transistors, as to whether the divided nodes are interconnected, and so on. The process steps of S20 and S21 are carried out again in a series of steps. In this case, various steps can be changed as necessary.

The user selects one logic gate from circuit diagram 60 displayed on the circuit-diagram window (S22). Additional information on the selected logic gate is read out of magnetic disk 56 (S23). The additional information includes the ID (identification) and name of the logic gate as well as the size information 68-72 (see FIG. 6) on transistors forming the logic gate. Referring to FIG. 6, when NAND gate 62, for example, is selected as a logic gate, size information 68 on transistors forming NAND gate 62 indicates that the gate length and gate width of a P channel transistor are 10 and 1 and that the gate length and gate width of an N channel transistor are 5 and 1.

Referring to FIG. 8, a logic gate type which corresponds to the logic gate name is determined (S24). By using an input device such as mouse 42 or keyboard 40, the user designates a location for generating a layout cell on the layout window (S25). The designation of the location for generating a layout cell may be carried out by designating one reference coordinate (such as a central coordinate or above left end coordinate) of the layout cell or by designating a reference coordinate of the layout cell corresponding to the set of P channel transistors and a reference coordinate of the layout cell corresponding to the sets of N channel transistors. The y coordinates may automatically be determined in a region where the layout cell is not arranged on base layout 80, and only the x coordinates may be designated by the user.

The location for arranging a transistor layout cell is calculated (S26). The location is calculated based on the information for arranging a transistor layout cell for every logic gate type, described below, which is separately stored in magnetic disk 56, on the coordinates where the layout cell which was designated at the process step of S25 is generated, and on the default values which were read at the process step of S5.

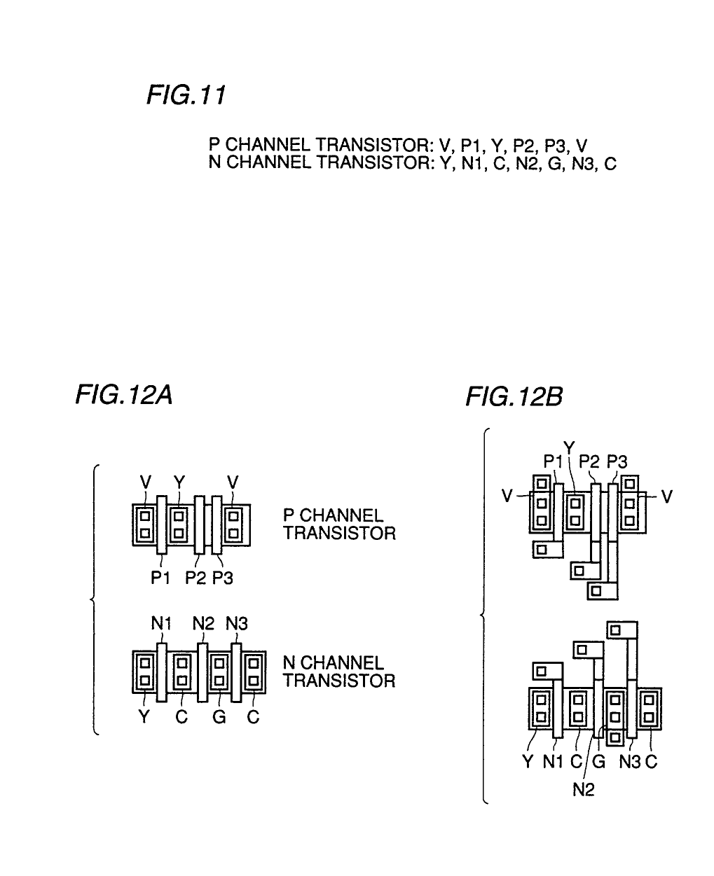

For example, when the logic gate type is an NAND-NOR gate shown in FIG. 10 the information for arranging a transistor layout cell which corresponds to the logic gate type is as described in FIG. 11. The information for arranging a layout cell indicates positional relationships among gate electrodes and metals to which contact holes belong. A P channel transistor includes gate electrodes P1-P3, a metal V of contact holes connected to a power supply, and a metal Y of contact holes connected to an output terminal OUT. An N channel transistor includes gate electrodes N1-N3, metal Y described above, a metal G of contact holes which are grounded, and a metal C of other contact holes. In other words, for the P channel transistor, metals and gate electrodes are arranged in the order of metal V, gate electrode P1, metal Y, gate electrode P2, gate electrode P3 and metal V from the left side. For the N channel transistor, metals and gate electrodes are arranged in the order of metal Y, gate electrode N1, metal C, gate electrode N2, metal G, gate electrode N3 and metal C from the left side. Here, gate electrodes P1 (N1), P2 (N2), P3 (N3) correspond to input signals IN1, IN2, IN3 of the NAND-NOR gate, respectively.

Referring to FIG. 9, based on the information for arranging a layout cell of transistors forming the NAND-NOR gate shown in FIG. 12A, a transistor layout cell is displayed on the layout window (S27). In this case, the ID of each layout cell also stores the ID of the logic gate, so that it can be seen that which logic gate each layout cell belongs to.

A location for generating a layout of an interconnection for supplying power to a transistor, an interconnection for grounding a transistor and an interconnection leading from a gate electrode, as additional interconnections of transistors, is calculated (S28). Whether these interconnections are generated or not is determined by the setting of S21. The layout of the interconnections is generated by using the name of the layer used for interconnecting transistors shown in FIG. 12B, and the width of interconnections, which were read from magnetic disk 56 in the process step of S5 (S29).

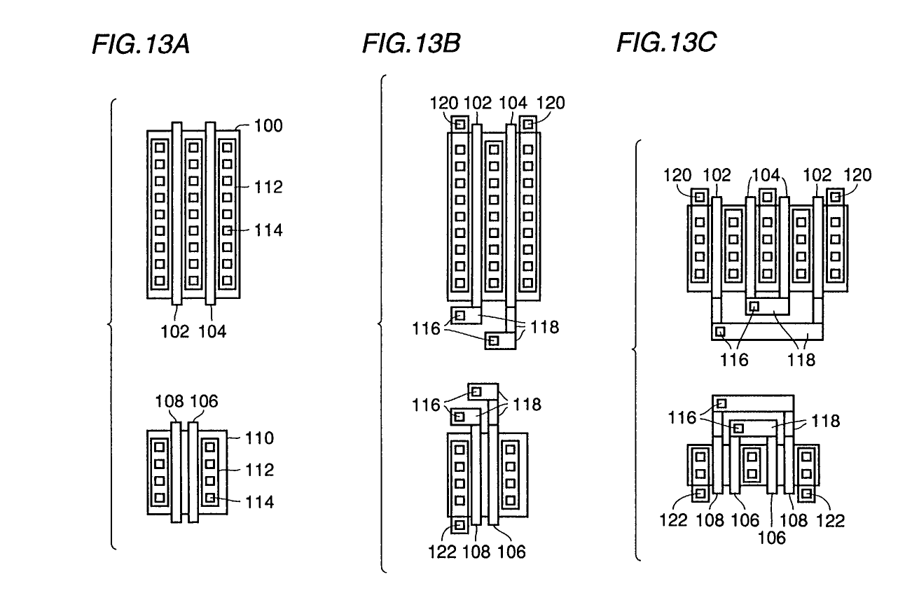

With respect to the layout of transistors forming NAND gate 62 shown in FIG. 13A, P channel transistors 102, 104, N channel transistors 106, 108, island 100 in the active region used for forming P channel transistors 102, 104, island 110 in the active region used for forming N channel transistors 106, 108, contact holes 114 in the source and drain regions of each transistor, and a metal 112 for an electrode are displayed as the transistor layout generated at the process step S27. In the following description, islands 100 and 110 in the active region each including P channel transistors 102, 104 and N channel transistors 106, 108, respectively, are displayed on the layout window.

P channel transistors 102, 104 are arranged in parallel. In other words, P channel transistors 102, 104 are arranged with contact holes 114 therebetween. Contact holes 114 are also arranged on the both sides of P channel transistors 102, 104. Here, contact holes 114 on one side, which are arranged on the both sides of P channel transistors 102, 104, are connected to the power supply, and contact holes 114 on the other side are connected to the output terminal.

N channel transistors 106, 108 are arranged in series. In other words, N channel transistors 106, 108 are arranged without contact holes 114 therebetween. Similarly to the arrangement of P channel transistors 102, 104, contact holes 114 are arranged on the both sides of N channel transistors 106, 108. Here, contact holes 114 on the other side, which are arranged on the both sides of N channel transistors, are grounded, and contact holes on the other side are connected to the output terminal.

Referring to FIG. 13B, the layout of transistors forming NAND gate 62 which has the layout of interconnections are generated at the process step of S29 further includes via holes 120, 122 and a metal interconnection for connecting to the power supply or grounding, a polysilicon interconnection 118 leading from a polysilicon electrode, and a contact hole 116 for switching from polysilicon interconnection 118 to the metal interconnection.

At the process steps of S26-S29, based on the settings at the process step S21, the layout of transistors may be generated to have transistors 102-108 each divided into two. In the drawing, the gate electrodes (polysilicon electrodes) of divided transistors 102-108 are also connected by gate interconnections (polysilicon interconnections) 118.

At the process step of S7 shown in FIG. 5, the layout of transistors for one selected logic gate is generated. However, when there are a plurality of selected logic gates, the layouts of transistors for the selected logic gates may be generated collectively.

In the layout of transistors for that logic gate which is formed of a large number of transistors, such as a composite gate, each transistor in the sets of P and N transistors can not freely be arranged if the set of P channel transistors and the set of N channel transistors are represented in one respective layout cell. According to the situation of surrounding layouts, it becomes impossible to freely arrange each transistor in the sets of P and N channel transistors, and thus the degree of freedom of layout is deteriorated. Therefore, the sets of P channel transistors and the set of N channel transistors may respectively be represented in a plurality of layout cells to increase the degree of freedom. In this case as well, transistors which can share one source or drain region are arranged in one island in the active region, and a transistor layout is generated based on condition on the connection between prescribed transistors corresponding to the type of the logic gate. Therefore, it is of course possible to lay out without lowering time efficiency as compared with the case in which a set of transistors is represented in one layout cell.

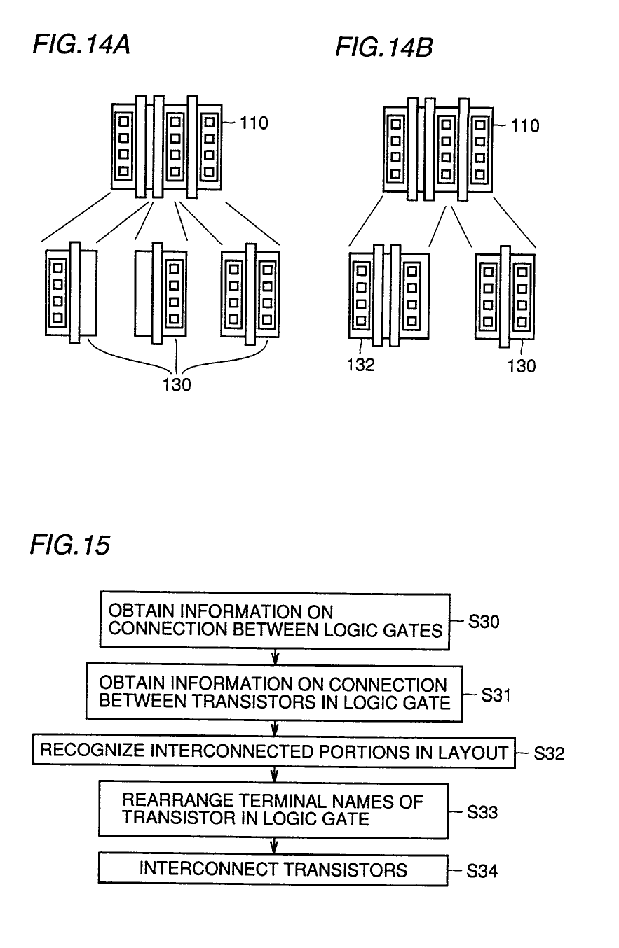

Referring to FIGS. 14A-14B, as the layout of adjacent transistors, that is, the structure of island 110 in the active region of transistors, a plurality of layout cells 130 each formed of a single transistor may be arranged or a layout cell formed of a plurality of transistors may be arranged as shown in FIG. 14A. Further a layout cell 132 formed of a plurality of transistors and layout cell 130 formed of a single transistor may be mixed as shown in FIG. 14B.

Referring again to FIG. 5, following the process step of S7, the user is asked to input the determination as to whether a layout of another logic gate is generated (S8). If the layout of another logic gate is to be generated (YES at S8), the process step of S7 is performed again.

If the layout of another logic gate is not to be generated (NO at S8), a determination is made whether a transistor layout is edited (S9). If layout editing is to be performed (YES at S9), the generated layout cells are rearranged to suitable locations and transistors are interconnected interactively with the user (S10). The user can edit the layout on the basis of a layout cell of each the sets of P and N channel transistors which is generated for every logic gate. Therefore, efficient layout editing is allowed as compared with the case in which layouts are edited for every transistor. Further, during the step of S10, the condition for generating layouts can be changed interactively. Thus, efficient layout editing is allowed without affecting the degree of freedom of laying out.

If layout editing is not to be performed (NO at S9), or after the process step of S10 is ended, the user determines whether there is any generation or editing of a layout to be redone or added (S11). If there is any (YES at S11), the processing after S6 is repeated. If there is not (NO at S11), transistors are interconnected (S12). The processing for interconnecting transistors will be described below.

After the process step of S12, the user determines whether there is any generation or editing of a layout, or interconnecting between transistors to be redone or added (S13). If there is any (YES at S13), the process steps after S6 are performed again. If there is not (NO at S13), the processing for closing unnecessary gaps formed by the layout cells and the interconnections, that is, compaction is carried out to compress the layouts (S14). Here, the compaction may be carried out as necessary at the layout editing stage (S10), for example. Thus, automatic generation of transistors forming a logic gate is completed.

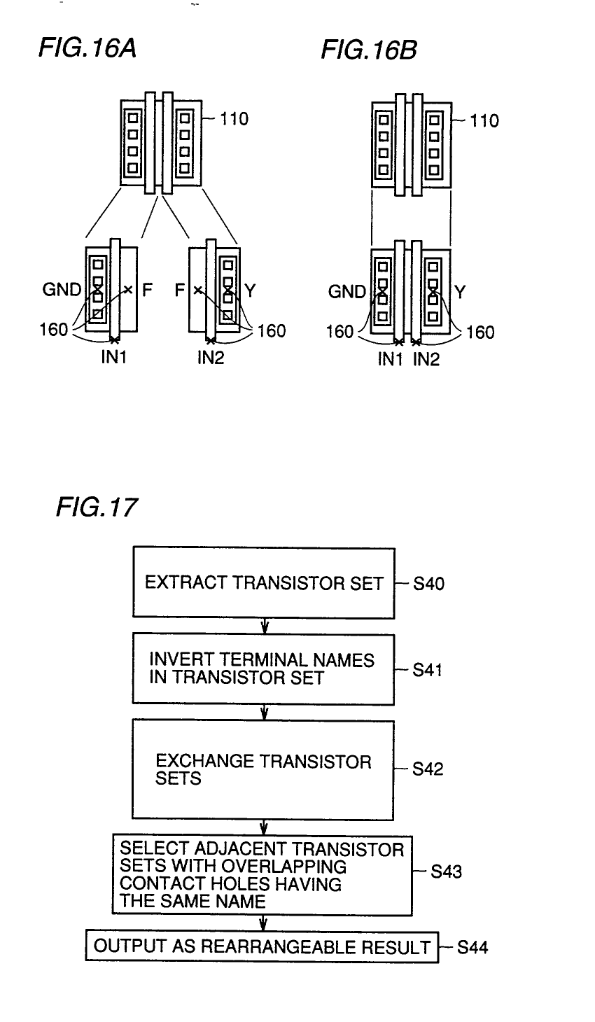

Referring to FIGS. 15, 16A and 16B, the process step of S12 will be described below in detail.

Information on connection between logic gates which form the circuit diagram displayed on the circuit-diagram window is read out of magnetic disk 56 (S30). Referring to FIG. 6, the information on connection between logic gates which form circuit diagram 60 specifies connection between the terminals of the logic gates, indicating, for example, “one input terminal of 2-input NAND gate 64 is connected to the output terminal of 2-input NAND gate 62, and the other input terminal of 2-input NAND gate 64 is connected to the output terminal of NOT gate 66”. Although the process step of S30 may be repeated in the series of steps, the information on connection between logic gates is not changed unless there is no change in the circuit diagram. When there is not any change, therefore, the step is skipped.

Information on connection between transistors which form each logic gate is read out of magnetic disk 56 (S31). For example, referring to FIG. 16A, when a single transistor is divided into a plurality of transistors for layout generation, the terminals of each transistor are given names (terminals GND, F, Y, IN1, IN2), and such connection information is obtained that the terminals having the same terminal name must be electrically interconnected. Here, the terminal names for the layout cell of a single transistor are as described in FIG. 16B. Here, the rule that the terminals having the same terminal name must be electrically connected is used as connection information. After different terminal names are given, however, which terminals should be connected may separately be described in a table or determined by a rule. Further, when a single layout cell as shown in FIG. 16B is dividedly generated as shown in FIG. 16A at the process steps of S7 and S10, a terminal name F is newly created.

Points which are already interconnected are recognized in the layout of transistors (S32). Other non-interconnected points between transistors are interconnected at the process steps after S33 described below.

Although the information on the connection between logic gates and the information on connection inside a logic gate which are obtained at the process steps of S30 and S31 determine connection between transistors, an optimum layout can be obtained by rearranging the terminal names. Therefore, according to the situation of surrounding layouts, the terminal names are rearranged as necessary (S33).

Referring to FIGS. 17, 18, 12A and 12B, the process step of S33 will be described in detail. A set of a gate electrode surrounded on the both sides by contact holes and a metal to which the contact holes belong (the set is referred to as a “transistor set” in this specification) is extracted (S40). Two transistor sets (V, P1, Y) and (Y, P2, P3, V) are extracted in a P channel transistor. Three transistors sets (Y, N1, C), (C, N2, G) and (G, N3, C) are extracted in an N channel transistor.

For each set extracted at the process step of S40, the terminal names in the set are inverted (S41). For example, the terminal names (V, P1, Y) are reversed to be (Y, P1, V), and the terminal names (Y, P2, P3, V) are reversed to be (V, P3, P2, Y).

The information for arranging the layout cell of P channel transistors and the information for arranging the layout cell of N channel transistors are obtained by exchanging the sets of gate electrodes and metals which are obtained by the process steps up to S41 (S42). Here, the transistor sets which have the same number of gate electrodes are to be exchanged. Further, the order of gate electrodes is not to be changed between the information for arranging the layout cell of P channel transistors and the information for arranging the layout cell of N channel transistors. That is, the appended numbers to gate electrodes P and N are in the same order both in the information for arranging P channel transistors and the information for arranging N channel transistors. For example, when {(V, P1, Y) (V, P3, P2, Y)} is extracted as the information for arranging the layout cell of P channel transistors, {(Y, N1, C) (G, N3, C) (G, N2, C)} can be extracted but {(Y, N1, C) (G, N2, C) (G, N3, C)} cannot be extracted as the information for arranging the layout cell of N channel transistors.

From the information for arranging the layout cell of P channel transistors and the information for arranging the layout cell of N channel transistors which are obtained by the process steps up to S42, the information for arranging the layout cell is selected in which a metal for the contact holes which are included in each set of transistors forming the information for arranging the layout cell is the same as a metal for the contact holes which are included in adjacent transistor set (S43). For example, {(Y, P1, V) (V, P3, P2, Y)} and {(Y, N1, C) (C, N3, G) (G, N2, C)} are the examples.

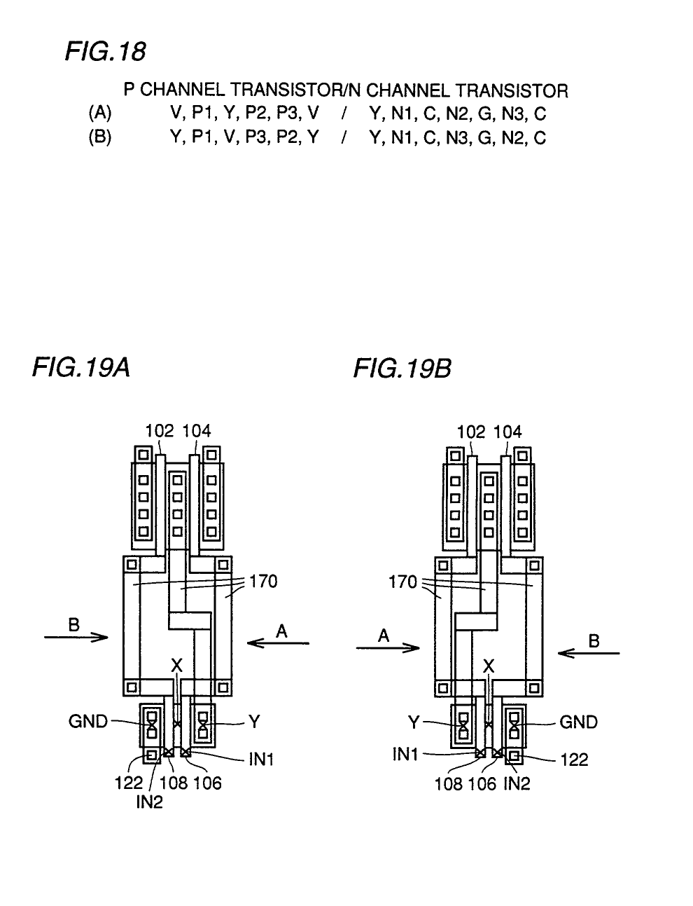

The information for arranging the layout cell which is selected by the process step of S43 is output as the information for arranging the layout cell as the result of rearranging the terminal names. The information for arranging the layout cell (see FIG. 18(A)) of transistors shown in FIG. 12A becomes new information for arranging the layout cell after the terminal names are rearranged as shown into FIG. 18(B).

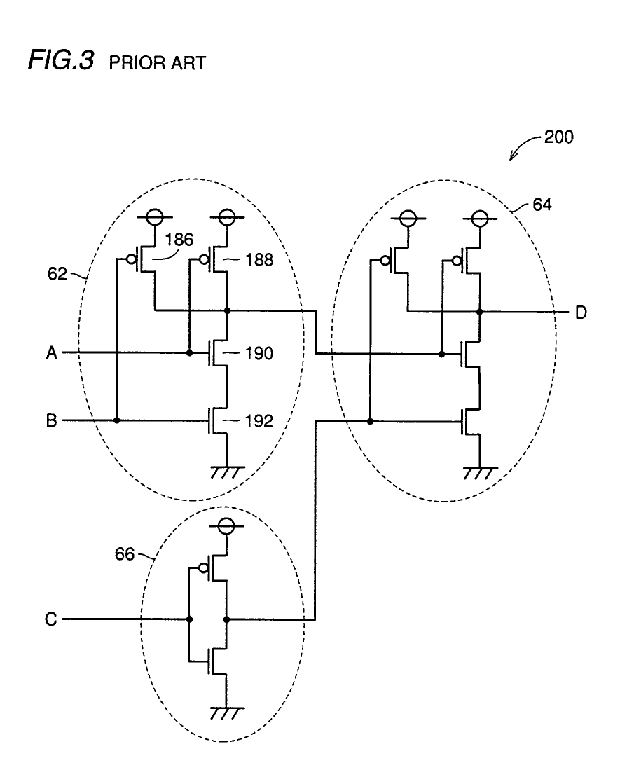

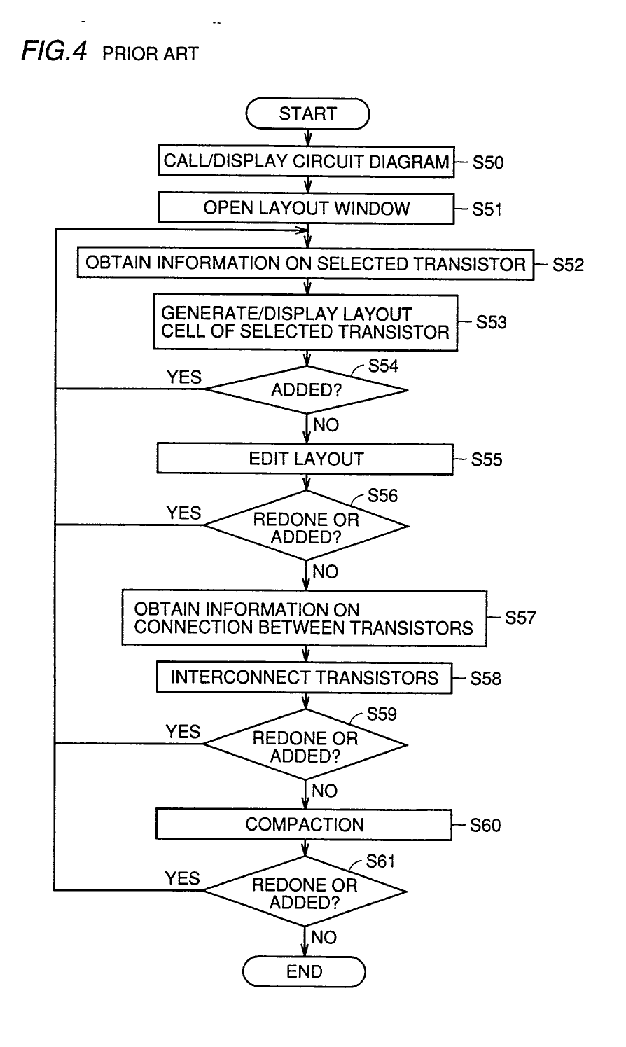

Referring to FIGS. 19A and 19B, the result of rearranging the terminal names in the layout cell of the NAND gate in FIG. 19A is shown in FIG. 19B. The propagation directions of inputs A and B are different for FIGS. 19A and 19B. Therefore, a layout is selected which allows intersection of the signal lines of input A and B as less as possible and which has a small layout area. N channel transistors 106, 108 in FIG. 19A correspond to N channel transistors 190, 192 in FIG. 3, and N channel transistors 106, 108 in FIG. 19B correspond to N channel transistors 192, 190 in FIG. 3. When one of these layouts is adapted, N channel transistors 106, 108 do not have to be actually moved for exchanging, and only the terminal names need to be rearranged. That is, the terminal names of source and drain electrodes can be exchanged because of the symmetry of an MOS transistor. Even when there are a plurality of adjacent MOS transistors, the terminals of each electrode can symmetrically be exchanged if these transistors are symmetrical.

It is assumed as an example that the terminal names of the source electrode/gate electrode/drain electrode for N channel transistor 108 of the 2-input NAND gate shown in FIG. 19A are GND/IN2/X, and the terminal names of the source electrode/gate electrode/drain electrode for N channel transistor 106 are X/IN1/Y. The terminal names are rearranged as shown in FIG. 19B.

Further, consider the case in which the user rearranges interconnection 170 to change the layout shown in FIG. 19A to the layout shown in FIG. 19B. In this case, N channel transistor 106 is short-circuited if the terminal names are not rearranged. However, such a condition is prevented by automatically rearranging the terminal names.

After the process step of S33, transistors are interconnected (S34). The 2-input NAND gate in FIG. 19 is an equivalent circuit as a logic circuit even if the input signals for the terminal names IN1 and IN2 are simply exchanged. Therefore, the terminals which are logically equivalent are connected so that the layout area and the interconnection length are reduced according to the situation of surrounding layouts. For example, the terminals having the terminal names IN1 and IN2 may be supplied with inputs A and B or inputs B and A. Selection of one of them is determined in accordance with the situation of surrounding layouts.

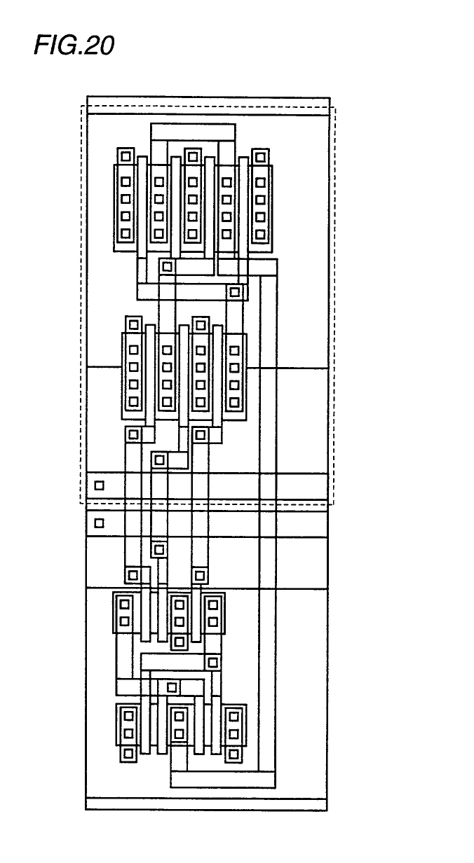

Referring to FIG. 20, in the layout of a semiconductor integrated circuit device which is designed by layout apparatus 31, the initial state of the layout is given, for every logic gate, as a block of islands in the transistor active region in which P and N channel transistors forming the logic gate are arranged as prescribed and provided with interconnections. Therefore, the ultimate form of the layout is easily assumed, and laying out can be done on the basis of an island in the transistor active region. Therefore, the time required for laying out can be reduced substantially. Thus, optimum laying out is allowed in a limited time period for layout designing.

If the structure of an automatically-generated layout cell of transistors which form a logic gate is not suitable according to the situation of surrounding layouts, the transistor layout cell can be divided, for example. Thus, the degree of freedom of laying out will not be deteriorated.

In the layout apparatus according to the present invention, a transistor layout is automatically generated based on electric connection which is preset for every logic gate type. Therefore, arranging and interconnecting on the basis of a transistor are not necessary as were in the past, and thus an efficient transistor layout with a high degree of integration can be obtained.

Since the terminals of each transistor are given terminal names, the terminals can automatically be interconnected based on the terminal names even if a layout cell and a transistor do not have one-two-one correspondence. Therefore, layouts with a high degree of integration can be interconnected efficiently.

By rearranging the terminal names of transistor terminals, the interconnection length and the layout cell arrangement area can be reduced while increasing the degree of integration.

The transistor layout cell is formed of islands in the active region of transistor which are obtained through sharing of source/drain regions. Therefore, the layout does not have to be edited on the basis of a transistor, and the whole image of the layout is easily obtained. Thus, an efficient transistor layout with a high degree of integration can be obtained.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An apparatus for laying out a transistor in a semiconductor integrated circuit, comprising:
means for selecting a logic gate forming the semiconductor integrated circuit; and
means for generating, for each said logic gate, a layout cell of transistors forming said logic gate based on size information on said transistors forming said logic gate and a type of said logic gate.

2. The apparatus for laying out according to claim 1, further comprising:
means for interconnecting said layout cells based on information on connection between said transistors forming said logic gate.

3. The apparatus for laying out according to claim 2, wherein
said information on connection between said transistors includes terminal names of terminals of said transistors, and
said means for interconnecting includes
means for rearranging said terminal names, and
means for interconnecting terminals having a same terminal name between said layout cells based on said rearranged terminal names.

4. The apparatus for laying out according to claim 3, wherein
said transistor includes a P channel transistor and an N channel transistor, and
said means for rearranging said terminal names includes
means for extracting a transistor set from each of information for arranging a layout cell of said P channel transistor and information for arranging a layout cell of said N channel transistor,
means for inverting terminal names included in said transistor set as necessary,
means for exchanging, as necessary, said transistor sets including a same number of terminals for each said information for arranging a layout cell, and
means for extracting, for each of said information for arranging a layout cell of said P channel transistor and said information for arranging a layout cell of said N channel transistor, said information for arranging a layout cell of said P channel transistor and said information for arranging a layout cell of said N channel transistor in which a terminal name of a metal which is included in said transistors set is same as a terminal name of a metal which is included in an adjacent transistor set and which is adjacent to said metal.

5. A method for laying out a transistor in a semiconductor integrated circuit, comprising the steps of:
selecting a logic gate forming the semiconductor integrated circuit; and
generating, for each said logic gate, a layout cell of transistors forming said logic gate based on size information on said transistors forming said logic gate and a type of said logic gate.

6. The method for laying out according to claim 5, further comprising the step of:
interconnecting said layout cells based on information on connection between said transistors forming said logic gate.

7. The method for laying out according to claim 6, wherein
said information on connection between said transistors includes terminal names of terminals of said transistors, and
said step of interconnecting includes the steps of
rearranging said terminal names, and
interconnecting terminals having a same terminal name between said layout cells based on said rearranged terminal names.

8. The method for laying out according to claim 7, wherein
said transistor includes a P channel transistor and an N channel transistor, and
said step of rearranging said terminal names includes the steps of
extracting a transistor set from each of information for arranging a layout cell of said P channel transistor and information for arranging a layout cell of said N channel transistor,
inverting terminal names included in said transistor set as necessary,
exchanging, as necessary, said transistor sets including a same number of terminals for each said information for arranging a layout cell, and
extracting, for each of said information for arranging a layout cell of said P channel transistor and said information for arranging a layout cell of said N channel transistor, said information for arranging a layout cell of said P channel transistor and said information for arranging a layout cell of said N channel transistor in which a terminal name of a metal which is included in said transistor set is same as a terminal name of a metal which is included in an adjacent transistor set and which is adjacent to said metal.

9. A method for manufacturing a semiconductor integrated circuit, comprising the steps of:
laying out a transistor in the semiconductor integrated circuit; and
manufacturing the semiconductor integrated circuit based on a result of said step of laying out,
said step of laying out including the steps of
selecting a logic gate forming the semiconductor integrated circuit, and
generating, for each said logic gate, a layout cell of transistors forming said logic gate based on size information on said transistors forming said logic gate and a type of said logic gate.

10. The method for manufacturing a semiconductor integrated circuit according to claim 9, further comprising the step of:
interconnecting said layout cells based on information on connection between said transistors forming said logic gate.

11. The method for manufacturing a semiconductor integrated circuit according to claim 10, wherein
said information on connection between said transistors includes terminal names of terminals of said transistors, and
said step of interconnecting includes the steps of
rearranging said terminal names, and
interconnecting terminals having a same terminal name between said layout cells based on said rearranged terminal names.

12. A method for manufacturing a semiconductor integrated circuit according to claim 11, wherein
said transistor includes a P channel transistor and an N channel transistor, and
said step of rearranging said terminal names includes the steps of
extracting a transistor set from each of information for arranging a layout cell of said P channel transistor and information for arranging a layout cell of said N channel transistor,
inverting terminal names included in said transistor set as necessary,
exchanging, as necessary, said transistor sets including a same number of terminals for each said information for arranging a layout cell, and
extracting, for each of said information for arranging a layout cell of said P channel transistor and said information for arranging a layout cell of said N channel transistor, said information for arranging a layout cell of said P channel transistor and said information for arranging a layout cell of said N channel transistor in which a terminal name of a metal which is included in said transistor set is same as a terminal name of a metal which is included in an adjacent transistor set and which is adjacent to said metal.
